(19) United States
(12) Patent Application Publication
(10) Pub. No.: US 2004/0162633 A1
(43) Pub. Date: Aug. 19, 2004

(54) Interactive vending apparatus and method for dispensing and ordering digital media

(76) Inventors: Sheldon Kraft, Sherman Oaks, CA (US); Jeffrey Brian Ringer, Sherman Oaks, CA (US)

Correspondence Address: TOD R. NISSLE, P.C., P.O. Box 55630, Phoenix, AZ, 85078, US

(21) Appl. No.: 10/782,610

(22) Filed: Feb. 19, 2004

Related U.S. Application Data
(60) Provisional application No. 60/449,031, filed on Feb. 19, 2003.
(60) Provisional application No. 60/449,032, filed on Feb. 19, 2003.
(60) Provisional application No. 60/449,033, filed on Feb. 19, 2003.
(60) Provisional application No. 60/449,034, filed on Feb. 19, 2003.
(60) Provisional application No. 60/449,035, filed on Feb. 19, 2003.

(51) Int. Cl. G06F 17/00

(52) U.S. Cl. 700/234

(57) ABSTRACT

An interactive vending machine is provided that facilitates the purchase of digital media. The machine includes audio speakers and a video screen that presents displays controlled by a consumer and that enables audio-visual promotional material and informational material to be produced on the vending machine in conjunction with purchasing digital media from the vending machine or from a source remote from the machine.

This invention pertains to vending machines.

More particularly, the invention pertains to a method and apparatus for dispensing and ordering digital audio-visual media from a vending machine.

As used herein, digital audio-visual media includes media that stores or produces an audible or video image using digital data. By way of example, and not limitation, digital audio-visual media includes DVDs, CDs, CD-ROMs, video games on digital discs (i.e., on CDs), digital cameras, and digital telephones.

Vending machines are well known in the art. A vending machine includes a housing, a chute or other merchandise removal area formed in the housing, and, a plurality of dispensing compartments. Each dispensing compartment includes at least one of a particular article. The vending machine also includes a system for receiving payment for the particular article and for dispensing the particular article from the dispensing department to the merchandise removal area after such payment is received.

One disadvantage of a conventional vending machine is that it provides only a minimal amount, if any, information about the articles that are in the machine and are offered for sale. This limitation is no moment when a vending machine offers for sale candy or gum or other well known food items. However, in the event it is desired to offer more complicated articles like DVDs, cameras, or telephones for sale, a potential customer often is interested in obtaining, before purchase, information concerning the article. Such information may consist of the memory or magnifying power available in a camera offered for sale; the free minutes included when a cell phone is purchased; information on the rating of a movie or information consisting of a clip or trailer from the movie; information describing the songs performed on a CD or on the artists that perform on the CD; and so on. Conventional vending machines offer little, if any, opportunity to obtain such information and, as a result, tend to limit the sale of digital audio-visual difficult.

Accordingly, it would be highly desirable to provide an improved vending machine that facilitates the sale of digital audio-visual media and other articles.

Therefore, it is a principal object of the instant invention to provide an improved vending machine.

A further object of the invention is to provide an improved vending machine that provides to a customer, with data obtained from the vending machine or from a source remote from the vending machine, supplemental information about an article offered for sale in the machine.

Another object of the invention is to provide an improved vending machine with a computer that correlates each dispensing compartment of the vending machine with the article offered for sale in the compartment, and correlates the article with informational data about the article.

Still a further object of the invention is to provide an improved vending machine that can produce an audio-visual video display of a portion of a digital audio-visual media offered for sale in the machine.

Still another object of the invention is to provide an improved vending machine that enables a customer to either purchase a particular article from the vending machine or to order the article from a location remote from the vending machine.

These and other, further and more specific objects and advantages of the invention will be apparent to those skilled in the art from the following detailed description thereof, taken in conjunction with the drawings, in which;

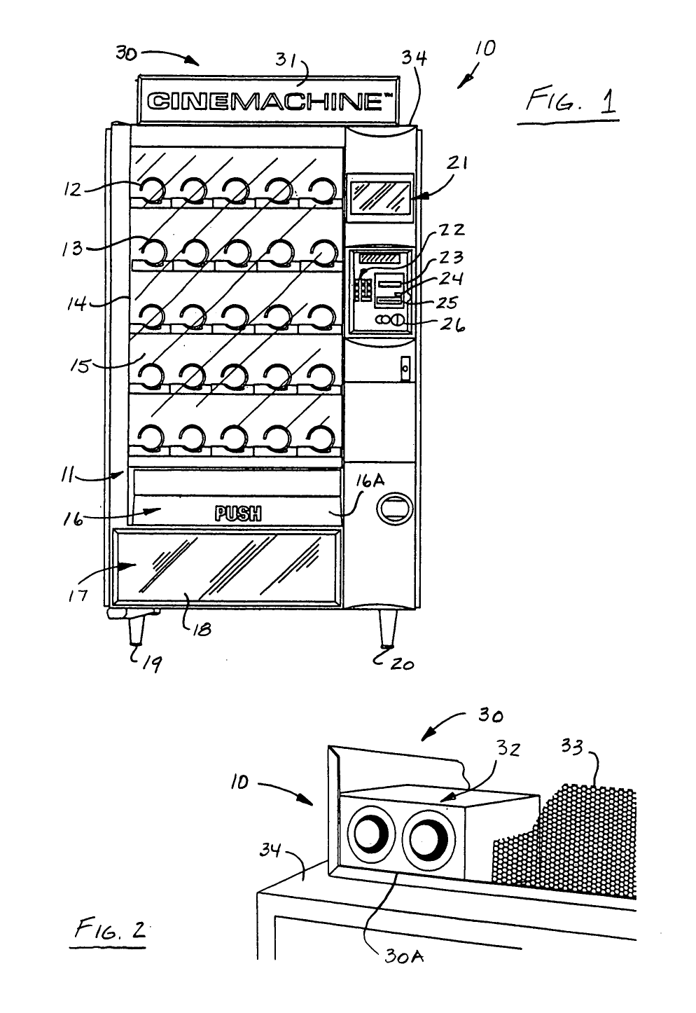

FIG. 1 is a front view illustrating a vending machine constructed in accordance with the principles of the invention;

FIG. 2 is a perspective view illustrating a portion of the speaker system in the vending machine of FIG. 1;

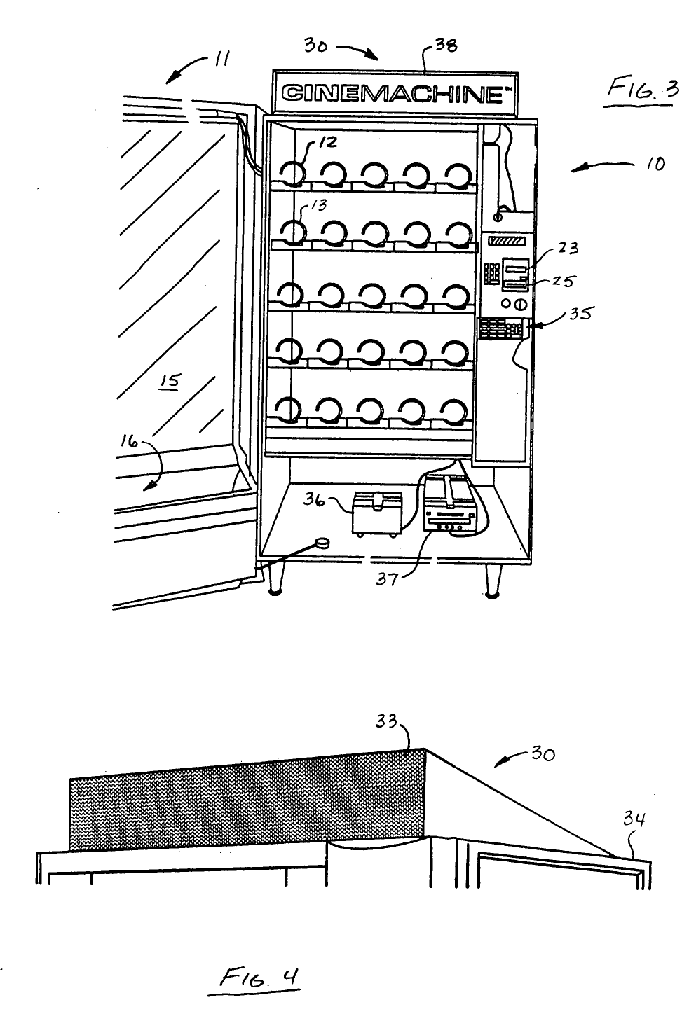

FIG. 3 is a front view of the vending machine of FIG. 1 with the door opened to access the interior of the machine;

FIG. 4 is a perspective view illustrating a speaker housing in the vending machine of FIG. 1;

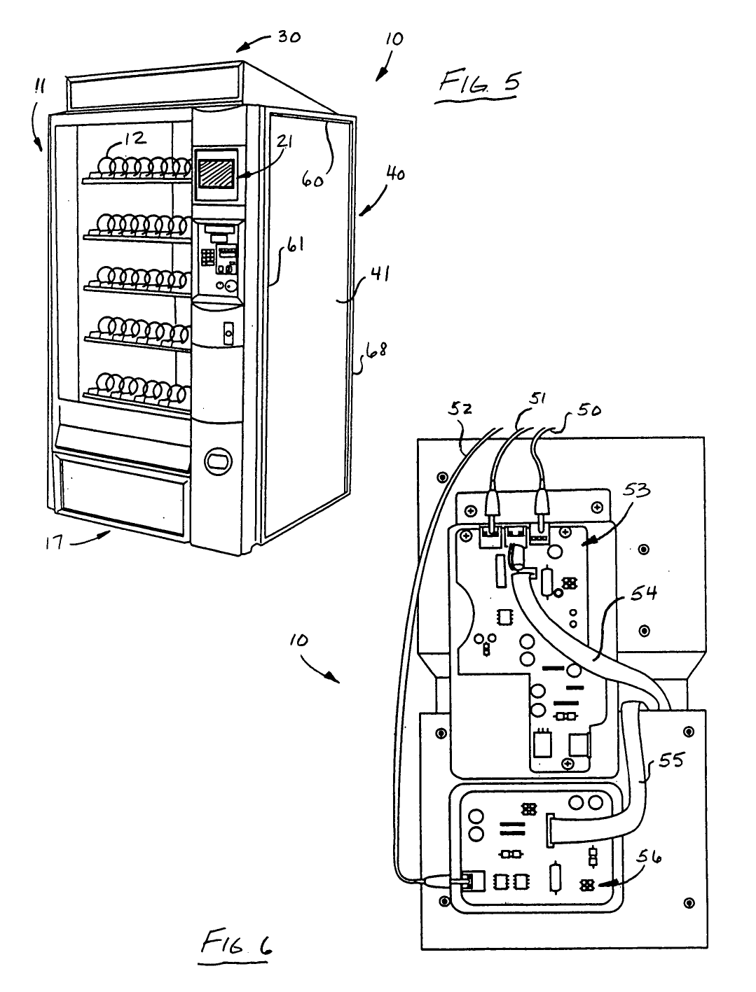

FIG. 5 is a perspective view illustrating additional construction details in the vending machine of FIG. 1;

FIG. 6 is a back view illustrating the back of the video screen and touch screen components in the vending machine of FIG. 1;

FIG. 7 is a back view of the door of the vending machine of FIG. 1 illustrating construction details thereof; and,

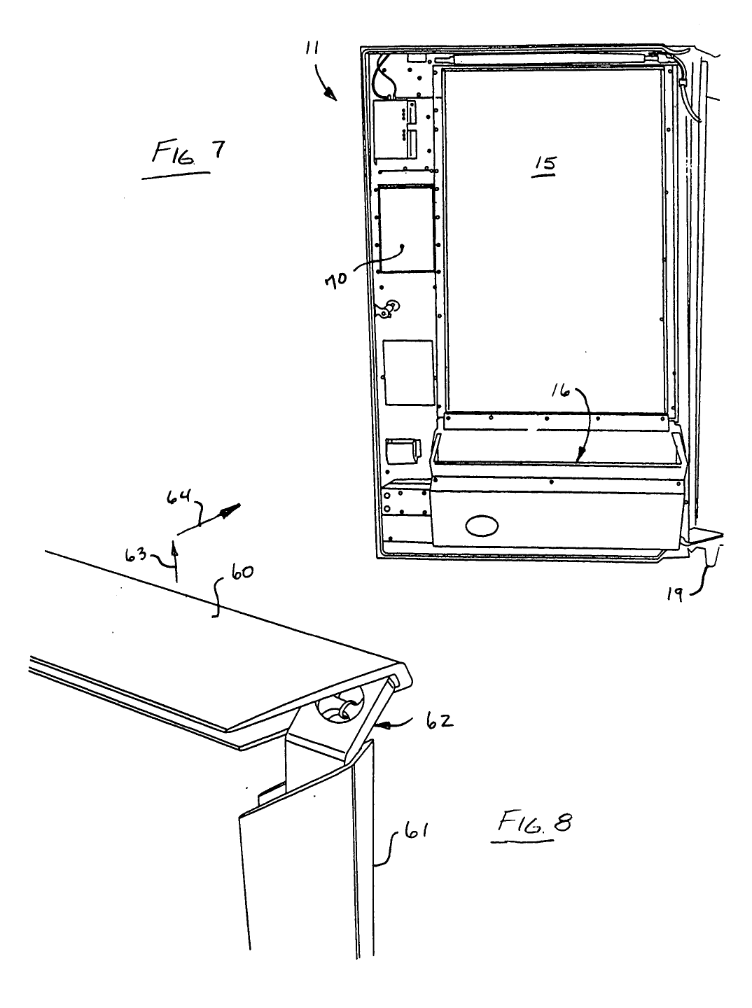

FIG. 8 is a perspective view of a portion of the frame of an advertising panel on the vending machine of FIG. 1 illustrating the mode of operation thereof.

Briefly, in accordance with the invention, I provide an improved interactive vending machine. The vending machine includes a merchandise removal area; and, a plurality of dispensing compartments. Each dispensing compartment includes at least one of a particular article, and a system to dispense the particular article to the merchandise removal area. The vending machine also includes a system for selecting one of the dispensing compartments to purchase the particular article in the dispensing compartment; a system for paying for the particular article; and, a video screen to display video information concerning the particular article.

In another embodiment of the invention, I provide an improved interactive vending machine for dispensing digital audio-visual media. The improved vending machine includes a merchandise removal area; and, a plurality of dispensing compartments. Each dispensing compartment includes at least one of a particular digital audio-video article, and a system to dispense the particular audio-visual article to the merchandise removal area. The vending machine also includes a system for selecting one of the dispensing compartments to purchase the particular article in the dispensing compartment; a system for paying for the particular article; a video screen to display video information concerning the particular article; and, a computer operatively associated with the video screen and including a memory for storing visual informational data for producing a video display on the video screen concerning said particular article, and a system for selecting the informational data to display the data on the video screen.

In a further embodiment of the invention, I provide an improved interactive vending machine for dispensing digital audio-visual media. The improved vending machine includes a merchandise removal area; and, a plurality of dispensing compartments each including at least one of a particular digital audio-video article, and a system to dispense the particular audio-visual article to the merchandise removal area; an opening for viewing the dispensing compartments; controls for selecting one of the dispensing compartments to purchase the particular article in the dispensing compartment; controls to pay for the particular article; and, at least one promotional area for posting advertisements, the promotional area being separate from the merchandise removal area, the opening, and the controls and being shaped to permit advertisements to be removably remounted in the promotional area.

In still another embodiment of the invention, I provide an improved interactive vending machine for dispensing digital audio-visual media. The vending machine includes a merchandise removal area; and, a plurality of dispensing compartments each including at least one of a particular digital audio-video article, and a system to dispense the particular audio-visual article to the merchandise removal area. The vending machine also includes a system for selecting one of the dispensing compartments to purchase the particular article in the dispensing compartment; a system for paying for the particular article by using customer information identifying a financial account; a video screen to display video information concerning the particular article; at least one audio speaker; and, a computer operatively associated with the video screen and the speaker. The computer includes a memory for storing visual informational data for producing a video display on the video screen concerning the particular article and for producing sounds on the speaker concerning the particular article; and, a system for selecting the informational data to display the data on the video screen and to produce the sounds on the speaker.

In still a further embodiment of the invention, I provide an improved interactive vending machine for dispensing digital audio-visual media. The vending machine includes a merchandise removal area; and, a plurality of dispensing compartments. Each compartment includes at least one of a particular digital audio-video article, and a system to dispense the particular audio-visual article to the merchandise removal area. The vending machine also includes a system for selecting one of the dispensing compartments to purchase the particular article in the dispensing compartment; a system for paying for the particular article by accessing a web site in a computer network and using customer information identifying a financial account; a video screen to display video information concerning the particular article; at least one audio speaker; and, a computer operatively associated with the video screen and the speaker.

In yet another embodiment of the invention, I provide a kit for retrofitting a vending machine to dispense digital audio-visual articles. The vending machine includes a merchandise removal area; a plurality of dispensing compartments each including a system to dispense at least one article from the dispensing compartment to the merchandise removal area; a system for selecting one of the dispensing compartments to dispense, on receiving payment for the article, the article into the merchandise removal area; and, a system for paying for the particular article. The kit includes a video screen to display video information concerning the particular article; and, a computer operatively associated with the video screen. The computer includes a memory for storing visual informational data for producing a video display on the video screen concerning the particular article; and, a system for selecting the informational data to display the data on the video screen.

Turning now to the drawings, which depict the presently preferred embodiments of the invention for the purpose of illustrating the practice thereof and not by way of limitation of the scope of the invention and in which like reference characters refer to corresponding elements throughout the several views, FIG. 1 illustrates a vending machine constructed in accordance with the principles of the invention and generally indicated by reference character 10. Vending machine 10 includes feet 19, 20 and merchandise removal area 16 formed in door 11. Flap 16A is inwardly pushed to access an article that is dispensed into removal area 16.

Door 11 includes opening 11 through which a customer views a plurality of dispensing compartments 12, 13 formed in machine 10. Each dispensing compartment 12, 13 includes a dispensing system for dispensing articles from a compartment 12, 13 into merchandise removal area 16. The dispensing system illustrated in FIG. 1 comprises a cylindrically shaped corkscrew or spring shaped member and a motor that rotates the member. When the motor rotates the corkscrew shaped member, an article of merchandise that earlier was inserted in the member is moved in a direction from the back of the machine 10 toward opening 14 and toward the transparent glass or polymer panel 15 that is mounted in opening 14. When the article reaches the end of the corkscrew shaped member that is closest to panel 15, the article falls free under gravity to removal area 16. The corkscrew dispensing system is, along with various other vending machine dispensing systems, well known in the art. Each compartment 12, 13 is identified with alphanumeric characters that are mounted adjacent the compartment 12, 13 and that are readily visible to a consumer. The price and description of an article in a compartment 12, 13 can also be displayed adjacent the compartment.

A customer can also determine the price by depressing on keyboard 22 (or on a keyboard displayed on screen 21) keys corresponding to the alphanumeric characters that identify the compartment. The cost of articles in compartment then appears on screen 21.

If desired, information concerning the articles in a compartment 12, 13 can be displayed on screen 21. Such information can, without limitation, include the brand of the articles, particular features concerning the operation or use of the article, warranty information, where to order the article on the Internet or another computer network, etc.

In another embodiment of the invention, promotional material continuously appears on screen 21. The promotional need not be associated with the articles in a compartment 12, but can be, if desired. A “MENU” button appears in a corner of the screen. When a customer wants to obtain information on an article being sold from the vending machine, the customer enters via keyboard 22 a command for a menu to appear on screen 21, or, alternatively, simply depresses touch sensitive screen 21 over the “MENU” button to make a menu appear on screen 21. A menu then appears on screen 21. The menu lists each compartment 12, 13 and the article dispensed from each compartment. The customer selects one of the compartments 12, 13 (i.e., selects the article being dispensed by the compartment by entering a command (for example the alphanumeric characters associated with the compartment from which the article is being dispensed) on keyboard 22, or, by entering a command on a keyboard or other touch sensitive button or symbol(s) displayed on screen 21. Information associated with the selected article or compartment appears on screen 21. The information can be background information or can advise the customer how to pay for the article the customer has selected.

The customer pays for the article by inserting paper currency or coins in slot 26 or by inserting a credit card, debit card, or other financial account card or identification member in slot or reader 25. Display screen 23 assists a customer using a credit card or other identification card or unit to pay for an article that is to be dispensed from one of the compartments 12, 13. Screen 23, by way of example, can display in conventional fashion a series of commands or information statements like “Insert card”, “Push credit or debit”, “The amount of your purchase is $10.32. If you accept push ‘Yes’”, (i.e., push yes on keyboard 22). If you don't accept, push ‘Cancel’” (i.e., push the cancel button 24). The commands associated with making a credit card, debit card, etc. purchase can also appear on video display screen 21. Screen 21 can be any desired kind of screen including, but not limited to, a CRT screen and a liquid crystal screen.

As shown in FIGS. 1 and 2, a speaker housing 30 is mounted on the top 34 of vending machine 10. A speaker 32 is mounted inside housing 30. The front of housing 30 includes a rectangular opening 30A that is covered with a sound permeable mesh 33. A display 31 of a trademark or other promotional material can be inserted in opening 30A or can be formed on mesh 33.

In FIG. 3, door 11 has been opened to show the interior of vending machine 10. An audio speaker 36 and DVD machine 37 are installed on the floor of machine 10. Keyboard 35 is used to program into the computer 70 (FIG. 7) in the machine the price of each article offered for sale and other desired information. The computer in the machine 10 also can be programmed by inserting in a CD or “floppy disc” reader (not shown) mounted in machine 10 a disc that includes digital data and/or software programs, and can be programmed by accessing the Internet and downloading software into the computer in machine 10. Computer 70 can be provided in conjunction with a computer that ordinarily would operate machine 10 by dispensing selected article when a consumer utilizes keyboard 22 to select an article and pays for the article, or, computer 70 can perform both the functions normally performed by the pre-existing vending machine computer and performed in accordance with the principles of the invention.

A display compartment 17 including a transparent window 18 is, as shown in FIG. 1, formed on the lower portion of the outside of door 11. A paper, placard, or other panel like member is slidably inserted in compartment 17 behind transparent window 18. Similarly, as shown in FIG. 5, a display compartment 40 including a transparent window 41 is formed on the side of machine 10. A display compartment that is parallel to and spaced apart from compartment 40 can be formed on the other side of the machine 10.

Compartment 40 includes top rail 60 and side rails 61 and 68. Either end of top rail 60 is connected to one of side rails 61 and 68 by a spring loaded connector 53 (FIG. 4) that includes a top member 55 and bottom member 54. The construction of connector 53 can be varied as desired, but connector 53 functions to permit top rail 60 to be lifted upwardly and outwardly in the directions indicated by arrows 63 and 64 such that a placard or other members bearing promotional words, pictures, or other symbols can be downwardly slidably inserted in compartment 40 intermediate transparent window 41 and the side of vending machine 10. After the placard is inserted, rail 60 is returned to its original position with each end of rail 60 adjacent the upper end of one of the side rails 61, 68.

The back of the video screen and touch screen components of vending machine 10 is illustrated in FIG. 6 and includes the control board 53 for the video screen 21, the control board 56 for the touch function of screen 21, control cable 54 extending from the screen 21 to board 53, control cable 55 extending from screen 21 to board 56, and cable 24 providing electrical power to the touch screen function of screen 21. Cables 50 and 51 provide power to the screen or monitor 21. Board 53 includes microprocessor or computer 70. Boards 53, 56 operate in conjunction with computer 70.

The following example is given by way of illustration, and not limitation, of the invention.

### EXAMPLE

Each compartment 12, 13 is filled with a plurality of copies of various movies. Compartment 12 includes ten copies of the movie “GONE WITH THE WIND”. Compartment 13 includes ten copies of the movie “TERMINATOR III”, and so on. The installer utilizes keyboard 35 to program into computer 70 the name of the movie in each compartment, the cost of the movie, and the alphanumeric code assigned to each compartment. Alternatively, the installer can utilize a CD or floppy disc or other media in conjunction with a disc reader (not shown) to install such information in computer 70. Or, the installer can use keyboard 35 or some other means provided in machine 10 to access the Internet, to go to a web site on the Internet (or other computer network), and to download the desired information into computer 70. The information downloaded into computer 70 can include web sites where a particular movie can be purchased using a credit card, debit card, or other medium that permits the company selling the movie to identify and receive payment from a credit card account, bank account, or other financial account for a movie that will either be dispensed from machine 10 to a user or that will be shipped to the user from a remote site. The information downloaded into computer 70 also permits at least one of the computers to operate DVD machine 37 to obtain from a DVD or CD in the machine 37 promotional material or other information and to display such information on screen 21. The information downloaded into computer 70 can include video and/or audio clips, trailers, movie star interviews, director interviews, etc. from one or more of the movies being sold by machine 10.

A customer views the promotional material in compartment 17, in compartment 40, and on screen 21 and approaches machine 10. The customer sees the movie “GONE WITH THE WIND” in dispensing compartment 12. He presses a finger against touch sensitive screen 21 over a MENU button that is in the upper right hand corner of screen 21. The computer 70 receives a signal that is generated when the customer presses the screen over the MENU button, and computer 70 sends a signal that removes from screen 21 the promotional material that was on screen 21. The signal from computer 70 also causes the HOME MENU in TABLE I to appear:

TABLE I
HOME MENU

| | | | MORE INFO |
|---|---|---|---|
| Compartment | MOVIE | COST | Press Button |
| 12 | Gone With the Wind | $12.50 | ▪ |
| A13 | Terminator III | $15.00 | ▪ |
| A14 | Love and War | $10.50 | ▪ |
| . | . | . | . |
| . | . | . | . |
| . | . | . | . |

Using data in the memory of computer 70, computer 70 produces the HOME MENU by correlating each dispensing compartment A12, A13, A14, etc. with the article (i.e., with the particular DVD) in the comparment, with the price for the movie, and with a button that enables the customer to obtain additional information about the movie. The additional information can, as noted, comprise any desired information relating to the movie, including but not limited to ordering information, clips from the movie, information concerning the making of the movie, interviews with cast members, information on how to buy the book on which the movie is based, etc. Compartment A12 corresponds to the compartment identified in FIG. 1 by reference character 12. Compartment A13 corresponds to the compartment identified in FIG. 1 by reference character 13. The customer presses the screen 21 over the “square” button at the end of the “Gone With the Wind” line to obtain more information. Computer 70 receives the signal generated when the screen 71 is pressed over the button, removes the HOME MENU from the screen 21, and causes the “ORDER MENU” in TABLE II to appear on the screen.

TABLE II
ORDER MENU
“GONE WITH THE WIND”
WHAT WOULD YOU LIKE TO DO?

| OPTION | PRESS BUTTON |
|---|---|
| 1. BUY MOVIE FROM MACHINE | ▪ |
| 2. BUY MOVIE ON INTERNET | ▪ |
| 3. VIEW MOVIE TRAILER | ▪ |
| 4. VIEW INTERVIEW WITH CLARK GABLE | ▪ |
| 5. VIEW INTERVIEW WITH DIRECTOR | ▪ |
| 6. RETURN TO HOME MENU | ▪ |
| 7. CANCEL AND RETURN TO PROMO | ▪ |

TABLE II, like TABLE I, is stored in the memory of computer 70.

As would be appreciated by those of skill in the art, machine 10 can be programmed such that a customer utilizes keyboard 22 to input the compartment designation of A12, and such that after keyboard 22 is used to input the compartment designation A12, the ORDER MENU of Table II appears on the screen 21.

If after the ORDER MENU appears on the screen, the customer presses touch sensitive screen 21 over the black square button displayed at the end of the line “2. BUY MOVIE ON INTERNET”, a signal is generated to computer 70. Computer 70 receives the signal and in response connects to a web site the Internet, removes the ORDER MENU from the screen and causes the home page of the web site to appear on screen. The customer follows the directions on the web site to order the movie ‘GONE WITH THE WIND.”.

If the customer presses screen 21 over the black square button displayed on screen 21 at the end of the line “3. VIEW MOVIE TRAILER”, a signal is generated to computer 70. Computer 70 receives the signal, removes the ORDER MENU from the screen, causes the video movie trailer from “GONE WITH THE WIND” to appear on screen 21 and causes sound associated with the trailer to be broadcast over the speakers 32, 36. After the video movie trailer is completed, computer 70 causes the ORDER MENU of TABLE II to reappear on the screen. The movie trailer can be stored in and recalled by computer from its memory, or can be accessed by computer 70 from a DVD in the DVD machine 37.

If the customer presses screen 21 over the black square button displayed on screen 21 at the end of the line “4. VIEW INTERVIEW WITH CLARK GABLE”, a signal is generated to computer 70. Computer 70 receives the signal, removes the ORDER MENU from the screen, causes an interview with Clark Gable to appear on screen 21 and causes sound associated with the interview to be broadcast over the speakers 32, 36. The interview can be stored in and recalled by computer from its memory, or can be accessed by computer 70 from a DVD in the DVD machine 37.

If the customer presses screen 21 over the black square button displayed at the end of the line “5. VIEW INTERVIEW WITH DIRECTOR”, a signal is generated to computer 70. Computer 70 receives the signal, removes the ORDER MENU from the screen, causes an interview with the director of “GONE WITH THE WIND” to appear on screen 21, and causes sound associated with the interview to be broadcast over the speakers 32, 36.

If the customer presses screen 21 over the black square button displayed at the end of the line “6. RETURN TO HOME MENU”, a signal is generated to computer 70. Computer 70 receives the signal, removes the ORDER MENU from the screen and causes the HOME MENU to appear on screen 21.

If the customer presses screen 21 over the back square button displayed at the end of the line “7. CANCEL AND RETURN TO PROMO”, a signal is generated to computer 70. Computer 70 receives the signal, removes the ORDER MENU from the screen and causes the reappearance on screen 21 of the promotional information that was originally on screen 21 before the customer first pressed the screen over the menu button displayed at a corner of the screen.

The customer elects to press screen 21 over the black square button displayed at the end of the line “1. BUY MOVIE FROM MACHINE” to generate a signal to computer 70. Computer 70 receives the signal, removes the ORDER MENU from the screen, and causes the menu in TABLE III to appear.

TABLE III
CREDIT/DEBIT CARD PURCHASE
Instructions
1. Insert your credit card or debit card in the slot of the reader.
2. The number of the card will appear in digital display 23.
Confirm that the number is correct. If the number
is correct, press the below button:
CARD NUMBER CORRECT: ▪
If the number is not correct, reinsert card or
press the cancel button.

After the “CARD NUMBER CORRECT” button is pressed, computer 70 causes the menu in TABLE IV to appear.

TABLE IV
PURCHASE MENU
The amount of your purchase is $12.50 + $0.13 tax = $12.63.
If this is acceptable, authorize purchase by pressing button below:
PURCHASE AUTHORIZED ▪
If this is not acceptable, press cancel button.

If this is not acceptable, press cancel button. If the cancel button is pressed, computer 70 removes the PURCHASE MENU from the screen and causes the original promotional message to be displayed on screen 21. If the PURCHASE AUTHORIZED button is depressed, the computer 70 removes the PURCHASE MENU from the screen 21 and causes the menu in TABLE V to appear:

TABLE V
RECEIPT
Feb. 28, 2004
“GONE WITH THE WIND”
$12.50 + $0.13 tax = $12.63
Credit Card No. xxxx xxxx xxxx 0345
Your receipt is being printed.
Thank you for your order.

If there is a printer in the credit card unit in machine 10, the printer prints a receipt. If there is no printer, machine 10 can be programmed to send a receipt to the e-mail address of the customer if the e-mail addressed is entered by the customer. Alternately, the customer's receipt will be his credit card bill.

After the receipt is printed, machine 10 activates the dispensing compartment 12 to cause one copy of the movie “GONE WITH THE WIND” to be dispensed from compartment 12 to fall under gravity into the merchandise removal area 16 of machine 10.

The computer 70 can be programmed in any desired fashion and the menus appearing on screen 21 can be designed in any desired fashion in accordance with the operation of machine 10.

In an alternate embodiment of the invention, a kit is provided to retrofit an existing vending machine. The vending machine includes a merchandise removal area 16; a plurality of dispensing compartments 12, 13 each including a system to dispense at least one article from the dispensing compartment to the merchandise removal area 16; a system 22 for selecting one of the dispensing compartment to dispense; and, a system 25, 26 to pay for the article dispensed.

The retrofit kit includes a video screen 21 to display video information concerning promotion information and concerning articles in the vending machine, includes an audio speaker system to produce audible sounds concerning promotional information and concerning articles in the vending machine; and, includes a computer 70. The promotional information can concern items not offered for sale by the vending machine and can concern articles in the vending machine. The computer includes a memory, is operatively associated with the video screen 21, includes visual information data stored in the memory to produce a video display on the video screen concerning each article offered for sale by the vending machine or concerning articles not offered for sale by the vending machine, and includes a system for selecting portions of the visual information to display on the video screen. The retrofit kit also includes

1. Instructions or software necessary to interface with software or control systems on the vending machine being retrofitted.

2. A system for programming computer 70 with data identifying each dispensing compartment 12, 13 and for correlating with each dispensing compartment 12, 13 the article dispensed by the dispensing compartment.

3. A system for connecting the computer to the Internet or to another computer network to enable the computer to access the computer network.

4. Data stored in memory or in a DVD machine or other apparatus operatively associated with and accessible by the computer to produce audio-visual movie clips, songs, etc. using the display screen and/or audio speaker system.

If the vending machine being retrofit to operate in the manner of the machine 10 does not includes a credit/debit card reader, the retrofit kit can also include a credit/debit card reader and instructions or a system for hooking the credit/debit card reader to a phone line or to another means for communicating with a remote computer that approves credit/debit card or other financial card purchases.

In use, the retrofit kit is installed on an existing vending machine such that the existing machine performs some or all of the functions earlier described herein with respect to machine 10. In some cases, it is desirable not to install video screen 21 and other components in the existing machine but it is instead desirable to install the components adjacent or on top of the existing machine.

The retrofit kit can include advertising compartments 17, 40 that can be mounted on the existing machine.

Some additional desirable features associated with machine 10 or with another vending machine or with other kinds of machines are described below.

As earlier noted, a vending machine 10 constructed in accordance with the invention can be provided with a processing system that reads and processes a credit card, debit card, “smart” card, or other media that contains information identifying or enabling the identification of a consumer and of a financial account that is used to pay for an item purchased from machine 10. Such a processing system can communicate with a remote payment center or computer using any desired communication equipment including, but not limited to, microwave, radio, a computer, and fiber optic communication systems. Any desired means can be used to pay for an item purchased from machine 10 or from an Internet site. In addition to credit, debit, and cash purchases noted earlier, a consumer can utilize his or her cell phone to call a processing computer or center and to provide to the processing computer authorization to pay for an item purchased from a particular vending or other machine. The computer then communicates with the vending machine 10 and authorizes a purchase. The customer makes a purchase from the vending machine 10. The machine 10 then communicates to the remote processing computer the amount of the purchase. The remote processing computer arranges for the customer to be billed on his cellular phone bill for the purchase the customer made from the vending machine.

The vending machine 10 or other machine utilized in conjunction with the invention can be provided with voice recognition software that enables a customer to provide verbally the responses necessary to make a purchase from machine 10. For example, screen 21 can display “Which movie would you like to purchase?” The customer responds “GONE WITH THE WIND”. Computer 70 interprets the customer's voice and then causes screen 21 to displays the question: “Would you like to pay with a credit card or debit card?”. The customer says “Credit card.” Computer 70 interprets the customer's voice and causes screen 21 to display: “Insert your card in the credit card reader at the right center of the machine.”, and so on. Further, if desired, machine 10 can, instead of providing visual displays of questions and commands and information on screen 21, provide verbal commands or questions or information. Therefore, in the example set forth above in this paragraph, computer 70 would, instead of displaying on screen 21 “Which movie would you like to purchase?”, cause the audible words “Which movie would you like to purchase” to be broadcast over the speaker system on machine. When machine 10 is programmed to verbally posit questions and commands and information, the machine 10 is also programmed to expect a verbal answer or other appropriate response from a customer with a predetermined reasonable period of time. If machine 10 does not receive a proper response, machine 10 repeats the question or information or takes some other desired action.

Vending machine 10 can be provided with a system that evaluates a unique physical characteristic of a customer in order to identify the customer when the customer is purchasing an article from the machine 10. Consequently, machine 10 can include a system for analyzing the voice of a customer, for analyzing a customer's fingerprint, for scanning the retina of a customer, or for analyzing the DNA of a customer.

Another feature that can be incorporated in the machine 10 or other machine used in accordance with the invention is a system for sensing the number of individuals that walk within a particular distance of machine 10. For example, a motion detector can be used to detect each individual that passes within a twenty-five foot radius of the machine. Computer 70 maintains a record of the number of individuals that pass within the twenty-five foot radius each day. Maintaining a record of the number of individuals that pass near machine 10 is important because it is information that can be used in determining the amount charged an individual or company to place advertising on machine 10 in a compartment 17, 40 that is to viewed by individuals that use or pass by machine 10.

Another desirable system for machine 10 or another machine used in accordance with the invention is a security camera that is mounted on, preferably inside, machine 10 to view individuals who approach the machine. The field of view of the security camera can be selected as desired, but the camera presently preferably has a field of view toward the front of the machine 10 such that the camera will view any individuals approaching the front of machine 10. The security camera can be operated continuously or intermittently, as desired. The camera memory normally is periodically cleared or erased or transmitted to a remote site for review.

Still a further feature that can be incorporated in machine 10 or in another machine utilized in accordance with the invention is an attenuation system for adjusting the loudness of sound produced by a speaker 32, 36. Such a system preferably includes a sensor that determines periodically the loudness of the ambient sound adjacent machine and that produces a signal indicating such loudness. Computer 70 receives the signal and causes any sound produced by a speaker 32, 36 to be louder than the ambient sound to help insure that a customer can hear audible sounds produced by a speaker 32, 36. The degree to which sound broadcast by speakers 32, 36 is louder than the ambient sound is adjustable in accordance with the wishes of the establishment using machine 10. For example, a noisy movie theater might request that the sound broadcast by a speaker 32, 36 be twenty decibels louder than the ambient sound. In the waiting room of a dental office, the sound broadcast by a speaker 32, 36 might be only five decibels louder than the ambient sound, or, might be less than or equal in loudness to the ambient sound.

Still another feature that can be incorporated in a machine 10 or other machine used in the invention, is a set of audio headsets. The headsets can be utilized in place of or in conjunction with audio speakers 32, 36.

Yet a further feature that can be incorporated in a machine used in the invention is an illuminated advertising compartment 17, 40. The illumination can be provided by any desired means including back lighting, the use of reflectors on the promotional material in a compartment 17 or 40, the use fluorescent materials on the promotional material, by a lamp, by a remote spotlight, etc.

Yet another embodiment of the invention is to utilize advertising compartments 17, 40 in combination with a display screen 21; with a speaker 32, 36; and, with a computer 70, 71 combined in a stand alone structure. Computer 70, 71 can be programmed to cause various promotional displays to appear on screen 21 and to permit a viewer to select and view information on various topics by using a touch screen incorporated in screen 21 or by using other selection means provided in the stand alone structure. The stand alone structure can also be programmed or constructed to access the Internet or other computer network using screen 21 or another system incorporated in the stand alone structure.

Yet still a further embodiment of the invention comprises utilizing the retrofit kit of the general type earlier described in combination with a vending machine 10 that comprises an ATM that dispenses cash to a customer. The retrofit kit can include advertising compartments 17 and 40 that can be mounted on exterior surface of the ATM to be viewed by customers that use the ATM.

Having set forth my invention in terms to enable those skilled in the art to understand and practice the invention and having set forth the presently preferred embodiments and uses thereof, I claim:

1. An interactive vending machine including
(a) a merchandise removal area;
(b) a plurality of dispensing compartments each including
(i) at least one of a particular article, and
(ii) a system to dispense said particular article to said merchandise removal area;
(c) a system for selecting one of said dispensing compartments to purchase said particular article in said dispensing compartment;
(d) a system for paying for said particular article; and,
(e) a video screen to display video information concerning said particular article.

2. An interactive vending machine for dispensing digital audio-visual media, the vending machine including
(a) a merchandise removal area;
(b) a plurality of dispensing compartments each including
(i) at least one of a particular digital audio-video article, and
(ii) a system to dispense said particular audio-visual article to said merchandise removal area;
(c) a system for selecting one of said dispensing compartments to purchase said particular article in said dispensing compartment;
(d) a system for paying for said particular article;
(e) a video screen to display video information concerning said particular article; and,
(f) a computer operatively associated with said video screen and including
(i) a memory for storing visual informational data for producing a video display on said video screen concerning said particular article, and
(ii) a system for selecting said informational data to display said data on said video screen.

3. An interactive vending machine for dispensing digital audio-visual media, the vending machine including
(a) a merchandise removal area;
(b) a plurality of dispensing compartments each including
(i) at least one of a particular digital audio-video article, and
(ii) a system to dispense said particular audio-visual article to said merchandise removal area;
(c) an opening for viewing said dispensing compartments;
(d) controls for selecting one of said dispensing compartments to purchase said particular article in said dispensing compartment;
(e) controls tor pay for said particular article; and,
(f) at least one promotional area for posting advertisements, said promotional area being separate from said merchandise removal area, said opening, and said controls and being shaped to permit advertisements to be removably remounted in said promotional area.

4. An interactive vending machine for dispensing digital audio-visual media, the vending machine including
(a) a merchandise removal area;
(b) a plurality of dispensing compartments each including
(i) at least one of a particular digital audio-video article, and
(ii) a system to dispense said particular audio-visual article to said merchandise removal area;
(c) a system for selecting one of said dispensing compartments to purchase said particular article in said dispensing compartment;
(d) a system for paying for said particular article by using customer information identifying a financial account;
(e) a video screen to display video information concerning said particular article;
(f) at least one audio speaker; and,
(g) a computer operatively associated with said video screen and said speaker and including
(i) a memory for storing visual informational data for producing a video display on said video screen concerning said particular article and for producing sounds on said speaker concerning said particular article, and
(ii) a system for selecting said informational data to display said data on said video screen and to produce said sounds on said speaker.

5. An interactive vending machine for dispensing digital audio-visual media, the vending machine including
(a) a merchandise removal area;
(b) a plurality of dispensing compartments each including
(i) at least one of a particular digital audio-video article, and
(ii) a system to dispense said particular audio-visual article to said merchandise removal area;
(c) a system for selecting one of said dispensing compartments to purchase said particular article in said dispensing compartment;
(d) a system for paying for said particular article by accessing a website in a computer network and using customer information identifying a financial account;
(e) a video screen to display video information concerning said particular article;
(f) at least one audio speaker.

6. A kit for retrofitting a vending machine to dispense digital audio-visual articles, the vending machine including
a merchandise removal area;
a plurality of dispensing compartments each including a system to dispense at least one article from said dispensing compartment to said merchandise removal area;
a system for selecting one of said dispensing compartments to dispense, on receiving payment for said article, said article into said merchandise removal area;
a system for paying for said particular article,
said kit including
(a) a video screen to display video information concerning said particular article;
(b) a computer operatively associated with said video screen and including
(i) a memory for storing visual informational data for producing a video display on said video screen concerning said particular article, and
(ii) a system for selecting said informational data to display said data on said video screen.
